(19) United States
(12) Patent Application Publication
(10) Pub. No.: US 2007/0218880 A1
(43) Pub. Date: Sep. 20, 2007

(54) Radio Access Network Database For Knowledge Of Radio Channel And Service Environment Network

(75) Inventors: Stefan Felter, Bromma (SE); Kenzo Urabe, Yokohama (JP)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/575,788

(22) PCT Filed: Sep. 28, 2004
(86) PCT No.: PCT/SE04/01382

§ 371 Date: Mar. 22, 2007

(51) Int. Cl. H04Q 7/38

(52) U.S. Cl. 455/414.1

(57) ABSTRACT

The present invention relates to an improved radio resource management in a telecommunication network. This is achieved by means of improving the information that is provided to the responsible resource management units. Such improvement is achieved by collecting various types of information from various sources and by refining said information in order to achieve an increased predictability of parameters that determine the resource needs of the network.

### FIELD OF THE INVENTION

The present invention relates to an improved management of radio resources in a radio access network.

### BACKGROUND OF THE INVENTION

A radio access network is the cellular mobile radio network where user equipments get access to supplied communication services through radio links. It includes Base Transceiver Stations (BTS), which transmit and receive radio signals to and from the user equipments, and Base Station Controllers (BSC), which is in control of communication links. The Base Station Controllers are connected to a core network, which interfaces the radio access network with other public network, e.g. the Public Switched Telephone Network (PSTN) or an Integrated Services Digital Network (ISDN).

Cellular mobile radio networks have evolved from analogue cellular systems, which mainly focus on voice transmission services, via digital cellular systems to 3^{rd} generation digital cellular systems, which are capable of handling multi-media transmission services such as voice, image, video, and data, using wider bandwidths than the predecessor systems.

In order to realise those flexible services, the Radio Resource Management (RRM) function, which is implemented in the radio access network, has evolved accordingly. Radio resource management in ₃rd generation systems, when regarded as system building blocks, basically incorporates four sub-systems: The admission control sub-system is responsible for admitting as many user equipments as possible and promising a requested quality of service during their sessions. The congestion control sub-system is responsible for control of the user equipments in the network and providing the requested quality of service. Link adaptation provides the appropriate channel coding, multiplexing and transmission so that the required SNIR for the link is enhanced. Finally, scheduling controls that as many data as possible are transmitted for the given requirements on quality of service.

### SUMMARY OF THE INVENTION

In telecommunication networks, and particularly in radio-based communication networks, it is desirable to have a good knowledge about available network resources and the user equipments using said resources. This is especially crucial with regard to a maximised usage of traffic capacity, advanced communication services requiring flexibility and a higher quality of service.

It is thus an object of the present invention to achieve an improved scheduling and thus an optimisation of the usage of radio network resources.

It is the principal idea of the present invention that the radio resource management of a communication network can be improved by means of improving the information that is provided to the responsible resource management units. Such improvement is achieved by collecting various types of information from various sources and by refining said information in order to achieve an increased predictability of parameters that determine the resource needs of the network.

This idea is realised by the method and system according to the present invention consisting of a number of functional units, which can be implemented in one or several network units. The system includes means for receiving and processing a variety of incoming information about the network and/or the user equipments, e.g., relating to network propagation conditions or service requirements, means for storing this information appropriately and achieving statistics for refining of said information. This statistics can then be used for prediction of services and channel properties, which can be provided as output information to, e.g., the Radio Resource Management of the communication network.

It is an advantage of the present invention that decisions for radio resource management and network planning can be made in a more intelligent and cognitive way.

It is another advantage of the present invention that the information for resource management is more detailed and can be updated dynamically in order to provide better resource planning.

It is still another advantage of the present invention that an adaptive inter-system service handover becomes available, thus providing an extended admission and/or congestion control incorporating other systems that are different from the system of interest into the RRM-handling range.

Other objects, advantages and novel features of the invention will become apparent from the following detailed description of the invention when considered in conjunction with the accompanying drawings and claims.

For a better understanding, reference is made to the following drawings and preferred embodiments of the invention.

### BRIEF DESCRIPTION OF THE DRAWINGS

FIG. 1 illustrates a functional model of the system according to the present invention.

FIG. 2 illustrates a user equipment moving through an area within a cell with different channel profiles depending on the location of said user equipment.

FIGS. 3a and 3b illustrate a capacity estimate for an estimated movement of a user equipment in relation to quality requirements of said user equipment.

FIG. 4 shows a part of cell area and possible influences on the radio propagation in said cell.

FIGS. 5a-5f illustrate some typical power delay profiles and angular profiles for certain propagation conditions.

FIG. 6 shows a Rake-receiver, which is improved by help of the present invention.

FIG. 7a shows an improvement by help of the present invention for an adaptive array antenna set of a receiver and FIG. 7b for the corresponding transmitter structure.

### DETAILED DESCRIPTION

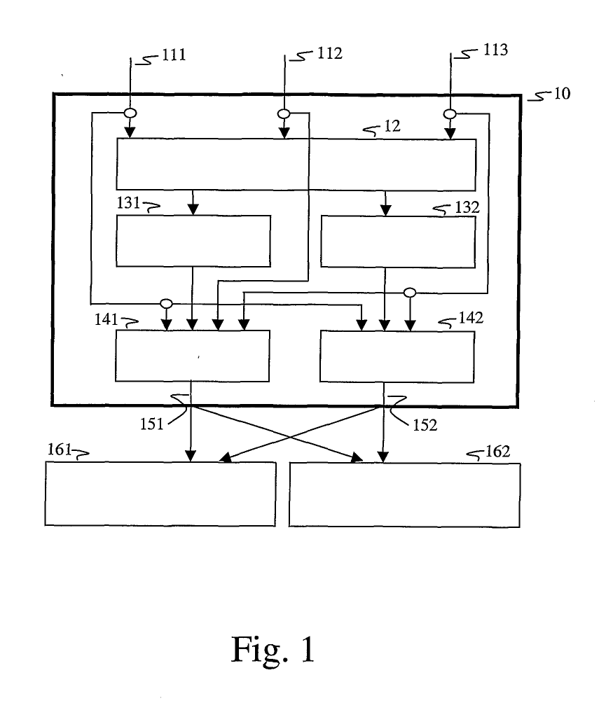

FIG. 1 shows a functional description of the system prediction database according to the present invention. Although it is herein depicted as one single building block 10 it is notwithstanding possible that the various functional parts of said system are implemented in different units of a radio access network, e.g. partly in a radio base station or Node-B of a cell or the user equipment and partly in the radio network controller which is in control of said radio base station. The system 10 is illustrated by means of a number of functional units processing on a set of appropriate input parameters 111,112,113 and delivering output prediction information 151,152 that can be used for various network management purposes.

Principally, the received input data can be distinguished into information 111 relating to a specific geographic position within a certain area, e.g. a cell, or information 112 relating to the behavior of user equipments, or the users itself, which use communication services of the network within a given area. The provided information can relate on the one hand to radio propagation conditions, i.e. channel properties and conditions on the uplink and/or downlink, and, on the other hand, to communication services, either as requested by the user equipments or provided by the network. Input information can further be regarded as dynamic parameters that change, e.g., periodically depending on the time of day, due to certain events or in response to other outer parameters. Said information can be retrieved either by active measurements initiated by the system 10 or based on feedback information that network units or user equipments within the network return to the system. Additional information 113, which is not retrievable by the system itself, can be obtained by help of an external input, e.g. the network operator. Such additional information can be useful, e.g., when initialising or expanding a network or due to outer changes of the system preconditions, e.g. a major change within the cell terrain or new service requirements within a certain area. The present invention thus aims to make use of a variety of different parameters and processing in order to increase prediction reliability and, thus, the performance of the radio access network.

Regarding the first group of input data relating to the geographic position, a cell can be considered to consist of areas with different prerequisites with regard to radio propagation conditions, e.g. due to the given terrain, buildings or other obstacles which have an influence on the radio propagation. These conditions can be reflected by channel estimates of the uplink or downlink, which can be parameterised, e.g., by help of the complex channel impulse response. From this function it is possible to derive further parameters describing the radio conditions, e.g. in form of a power delay profile, average propagation delay times, or the path loss. Further, the cell can also be sub-divided according to prerequisites related to the behavior of the user equipment, e.g. regarding the expected demands on channel capacity caused by the type of service requirements and the amount and distribution of such requirements that can be regarded to be typical within a certain area. Such a service requirement distribution depends of course also on the influence of infrastructure and terrain prerequisites and the distribution of user equipments within said areas. In general, all kinds of parameters that might be interesting for cell planning can also be regarded to be relevant as input information for the system prediction database according to the present invention.

The other group of input parameters relates to the user equipments and, if possible, to the users itself. Any radio resource management cannot be efficiently optimised by only relying on the given prerequisites of the radio access network. In addition, such management must also include the behavior and requirements of the user equipments within the environment that is served by said network. As distinguished above, such information relates, e.g., to geographic prerequisites resulting in information about position and movement, i.e. velocity and other appropriate derivates of higher order. It is a basic insight of the present invention that an increased knowledge of said movement of user equipments within an area also increases the predictability of the channel capacity of said user equipments and, by that means, the overall network performance and satisfaction of the individual user equipment. The user equipment can also be characterised by means of its typical behavior with respect to applied services, i.e. which kinds of services the user equipment requires, the duration of service sessions, and at which times. This information can be combined, e.g., with the user identity or the subscription type of the user equipment. Parameters related to user equipments can be used to achieve a more generalised model of user equipments, e.g. a typical user equipment within a certain cell area and/or related to the time of day, or, if possible, to achieve a generalised model of the behavior of the individual user equipment.

The specific advantage of an increased predictability of the needed network resources, their distribution with regard to time and location, and the performance requirements is achieved by combining the different types of received input parameters. The system according to the present invention is capable to combine and use the variety of different types of input parameters for a further processing that allows an optimisation of the resource management of the network, and thus the network system capacity, with regard to radio access conditions and service requirements seen as function over time for a certain coverage area of the radio access network serving user equipments with specific behaviours within said coverage area.

Received input data is first handled by a pre-processing unit 12, which has the task to sort and filter the incoming information that is supplied by the various inputs 111,112,113. A sorting of said data provides then the corresponding input data to the functional units of the inventive system. For an example embodiment of the present invention as described below, the input data can be sorted, e.g., into data relating to radio requirements or relating to service requirements either with regard to the user equipment or the network, respectively. Another task of the pre-processing unit 12 is to convert the received information in a way that simplifies further processing, e.g. by help of quantising and/or normalising received data, and to compress said data in order to efficiently use the storing facilities that are necessary to perform the following statistical evaluation of the provided input data. Compressing of information may include, inter alia, a categorisation of data into clusters of information that represents, e.g., a certain geographical area or a restriction of the processed data on a selection of relevant information data that is forwarded to the system. Optionally, the data can be stored in a quantised form covering a finite number of levels in order to make storing more feasible.

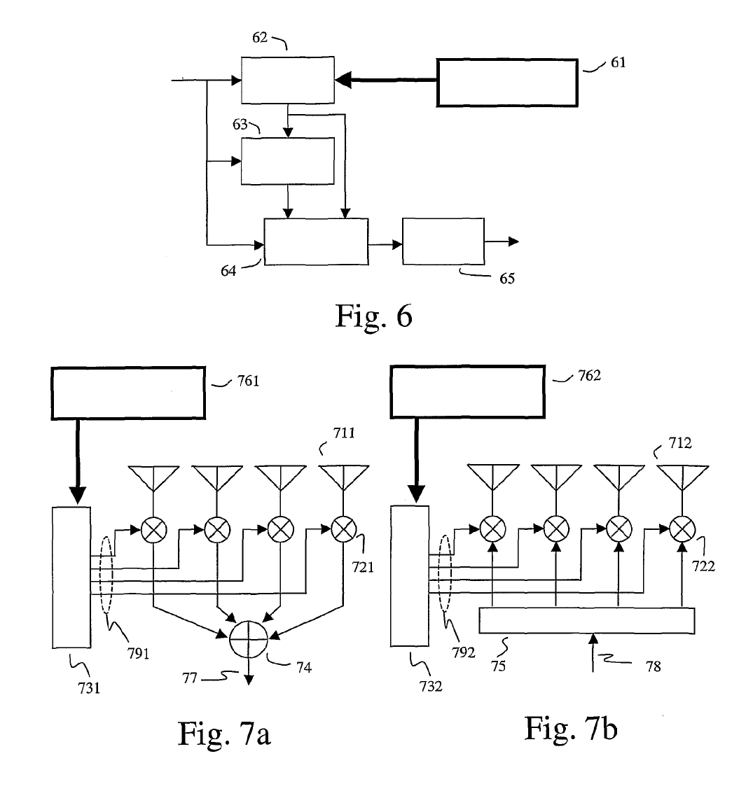

The system according to the present invention can provide improved information and parameter prediction by help of a statistic processing of received input data. Information that has been identified to be radio related parameters can be forwarded to a channel statistics sub-function 142, which evaluates and predicts the radio propagation characteristics for selected areas of a cell. The channel statistics sub-function processes said data by help of a channel statistics database 132 but also by using other kinds of available input information. By help of said database 132 the radio access network can achieve a proactive low-layer resource allocation and catch-up control to improve link quality. The information of the channel statistics database 132 can advantageously be used for a short-term optimisation of the system capacity, i.e. optimised link adaptation and resource scheduling of each user equipment depending on its location, while maintaining the required quality of service. In analogy to this, the system 10 also provides a service requirement sub-function 141 for evaluating received information and delivering prediction values regarding the availability and requirements of certain services. The service requirement sub-function 141 processes said data by help of a service statistics database 131 and other appropriate information delivered by the system input 111,112,113. The output of the channel statistics sub-function 142 and the service requirement sub-function 141 can be forwarded to other units of the radio network, e.g. the radio resource management 161 or lower layer functions 162 as illustrated in FIGS. 6 and 7a,7b.

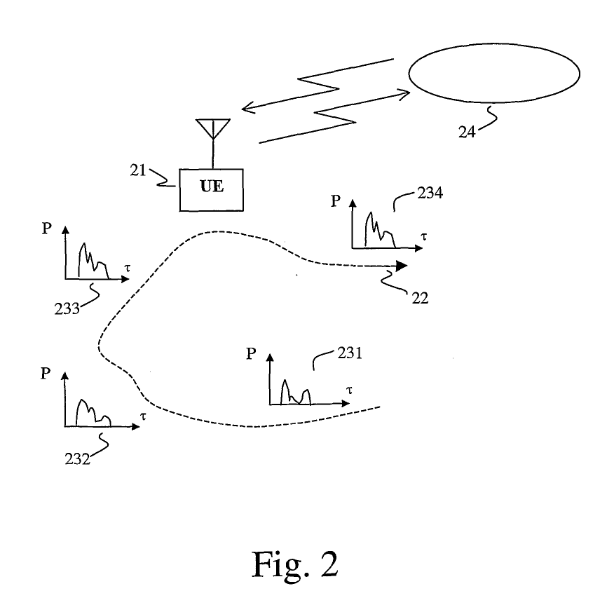

FIG. 2 shows an example of retrieving a channel statistics that is based on the Power Delay Profile (PDP), which reflects the channel quality in terms of a delay profile associated with the location of a user equipment. A user equipment 21, which moves along a line 22 through a cell area, provides the inventive system 24 at certain instances of time or in conjunction with certain events with channel profile information 231,232,233,234 at distinct locations within said cell. This can be done on request of said system 24 or initiated by the user equipment 21, e.g. when the user equipment transmits other information to the network. In an embodiment of the present invention the inventive system 24 can be configured to update and store an appropriate representation of the received profile information from a variety of locations 231,232,233,234. This updating can be performed, e.g., through communication link operations with the user equipment 21. Parameter updating is thus preferably performed by means of a learning process, which details are described below.

There are several parameters that can be taken into account for representation of a channel profile. The following indicates by means of example some of these parameters. The power delay profile, as illustrated in FIG. 2, can be expressed as

$$p ( τ ) = \frac{1}{N} {\sum }_{n = 1}^{N} \frac{{\vert {h}_{n} ( τ ) \vert}^{2}}{{P}_{n}}$$

where hₙ (τ) is the n^{th} measured sample of the complex channel impulse response, N the number of impulse response measurements, and Pₙ denotes the received power of the n^{th} measured sample of the complex channel impulse response, i.e. Pₙ=∫|h_{n,} (τ)|²dτ. In a real system, hₙ (τ) is handled as a function in the discrete time-domain formed by path positions τ₀,τ₁, . . .,τ_{L-1}, which are detected by a path searcher. When L denotes the number of detected paths, the channel impulse response, and accordingly the power delay profile, is represented by an L-dimensional vector.

In analogy to this, an angular profile Ω(θ), which is a normalised average received power angular profile, can be defined as

$$Ω ( θ ) = \frac{1}{N} {\sum }_{n = 1}^{N} \frac{{\vert {g}_{n} ( θ ) \vert}^{2}}{{P}_{An}}$$

where gₙ (θ) is the n^{th} measured sample of the complex angular profile of received signals arriving at the antenna, N the number of angular profile measurements, and P_{An} denotes the received power of the n^{th} measured sample of the complex angular profile, i.e. P_{An}=∫|gₙ (θ)|²dθ. In a real antenna system, gₙ (τ) is handled as a function on a discrete angle domain formed by the angles of arrival θ₀, θ₁, . . . ,θ_{L-1}, which are detected by an adaptive antenna system. When L denotes the number of detected paths, the power angular profile is represented by an L-dimensional vector.

Another channel profile parameter is the average received power for a desired user equipment Pₐᵥ=<Pₙ>, whereby Pₙ is the received power of the n^{th} measured sample of the complex channel impulse response, as described above, and the function <·> denotes the ensemble average over n samples. This parameter can be used, e.g., for an estimation of the average channel quality in service operation.

When using the power delay profile p(τ), as defined above, as a probability density function of a delay time τit is possible to define an RMS delay spread

$${τ}_{RMS} = \sqrt{{\int }_{τ = 0}^{∞} {( τ - 〈 τ 〉 )}^{2} p ( τ ) ⅆ τ} ,$$

whereby

$$〈 τ 〉 = {\int }_{τ = 0}^{∞} τ \cdot p ( τ ) ⅆ τ$$

denotes the average delay time. These parameters can be used for an estimation of a high speed data link capability to link adaptation.

A further channel profile parameter for estimation of the required transmission power but also for an estimate of the service coverage and hand-over requirements is the path loss, which can be defined as PL=10·log|P_{T}/Pₐᵥ|where P_{T} represents the TX-power of the user equipment of interest and Pₐᵥ represents the average received power for such a user equipment as defined above.

According to another aspect of the present invention, the system also receives and processes information relating to services that are provided by the network. In the same way as it is important to have a knowledge about the radio propagation conditions at the various locations within a cell of a network, it is also beneficial to have a good knowledge about the type of services that are requested within said areas. Such information can be applied, inter alia, to achieve a statistical measurement, e.g. regarding the need for resource allocation or quality of service, or at which time which types of services are requested. When combined with the channel prediction information the service requirement statistics can be applied, e.g., for decisions that have an influence on the network resource allocation during a longer time such as admission control or congestion control. Examples of service parameters that can be stored in a service requirement statistics database are the average traffic congestion level, the average interference level along with certain requirements on quality of service that must be fulfilled in a cell. Another aspect for a service requirement statistics is the service availability of other communication systems, e.g. various types of local area networks. Service parameters, e.g. the congestion or interference level, should preferably be accompanied by a time information of an appropriate resolution, e.g. in terms of hours, day, or month, so that the radio access network can identify or anticipate the average traffic status for a specific location where a user equipment of interest stays or intends to move to.

From the information that the system has collected and appropriately stored in the system database the channel prediction sub-function can now calculate prediction values for the channel profile parameters by using the a-priori refined information of the channel statistics database. Correspondingly, a service requirement prediction sub-function can predict the necessary amount of resources with regard to offered and required services in the cell and the momentary cell load. From said received and/or refined information it is now possible to achieve various kinds of prediction values that can be used for further management purposes as will be explained below. Such prediction values rely on the fact that the stored information has an increased degree of reliability and remains predictable for a certain time period, which can be retrieved, e.g., by help of analysing the received feedback information or by external adjustments. The reliability of the prediction values can be evaluated from previously stored information, statistical measures, e.g. mean value and variance, or other kind of information. The predictable time period will, on the other hand, also be an input parameter for the system how often the channel measurement values must be updated.

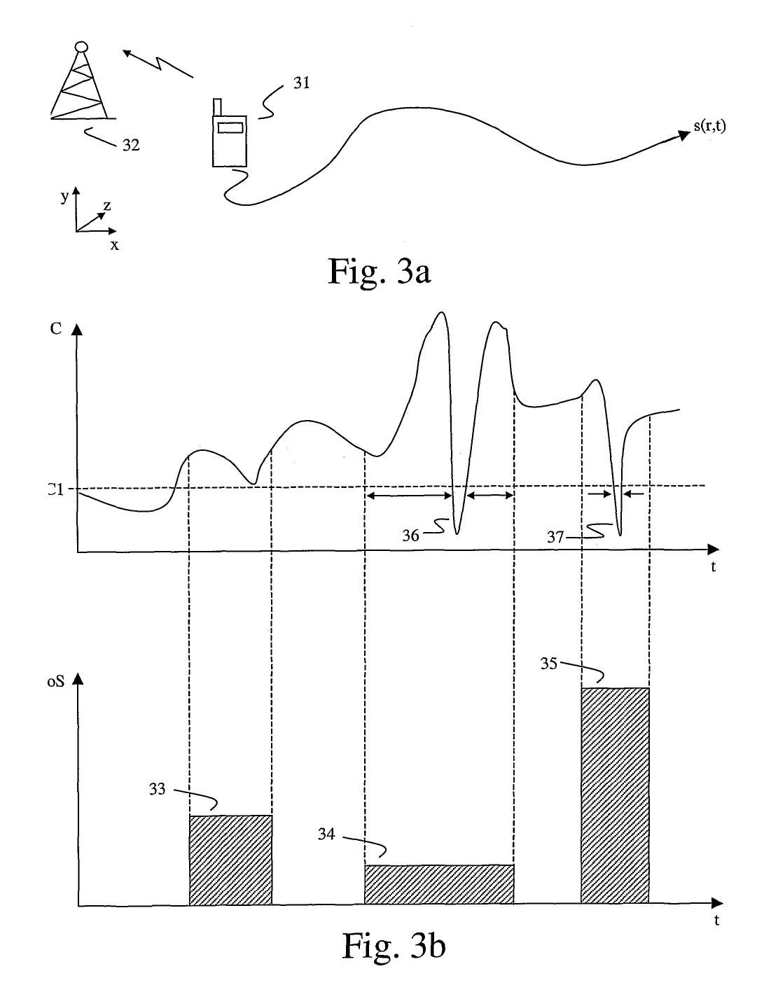

FIGS. 3a and 3b illustrate a capacity estimate for an estimated movement of a user equipment 31 in relation to quality requirements of said user equipment. The movement of the user equipment 31 through a cell area is described by help of a function s(r,t) depicting the location r of a user equipment together with a time reference value t. As illustrated in FIG. 2, the user equipment 31 sends measurement reports to its serving radio base station 32 and, thus, the system prediction database according to the present invention. From the measurement values for position and direction it is possible to achieve further derivates, e.g. velocity and acceleration. When processing this received data, the system prediction database retrieves information of the channel and service conditions at the certain location r and time t, which, e.g., can be used for estimates of other user equipments passing this location. The system prediction database also retrieves information about the user equipment itself and can thus retrieve a prediction value of s(r,t), i.e. a prediction of the presumed further movement of the user equipment. Out of these two kinds of information the system information database can now retrieve, as shown in FIG. 3b, a channel capacity function C for the presumed movement of the user equipment and the presumed propagation conditions along this way of the user equipment. This estimated function is now used together with information of the required quality of service of the user equipment. The radio access network can, e.g., use the system prediction database for congestion and admission purposes as it is now possible to predict the channel capacity and, thus, predict whether the channel capacity will drop under a certain minimum level Cl during the expected length of the service. This can be applied, e.g., for real-time based services like speech services 33. In case of non real-time based services, e.g. various types of data downloads 34, the present invention can be used for time scheduling purposes in case the channel capacity function indicates, e.g., a fading dip 36 during the expected download period. The download is then interrupted during periods where the channel capacity is below an acceptable threshold. Also in case of a service requiring a high quality of service, e.g. a video call 35, the prediction of the channel capacity can be used for admission or congestion control; alternatively it might be conceivable to negotiate on a different quality of service or a different starting time. The minimum level C1 of the channel capacity function can be defined generally for all kinds of service or individually for each service such that, e.g. a real-time based service having high demands on quality of service claim a comparatively higher minimum level than a non real-time based service with lower demands on quality of service.

The following illustrates an example of a support for a radio resource management function. The system according to the present invention provides the advantage that it is possible to achieve a resource management planning based on previously stored and refined information that relates on the one hand to demands on the communication network due to service requirements and on the other hand information that relates to the actual radio conditions of said network. The system according to the present invention can now extract a prediction information report for other network units that can be used, e.g., for purposes of a more efficient radio resource management in order to achieve or maintain a certain quality of service. When assuming a limited amount of resources in the radio access network, the radio resource management function must distribute these resources according to a certain strategy, e.g. in order to achieve a high total throughput given a certain level for the quality of service.

Key parameters for defining the quality of service are, e.g., the user bit rate and time delay. The system generates for a specific user equipment prediction values for the assumed movement of the user equipment and the present situation of the user equipment with regard to radio propagation conditions, e.g. described by the power delay profile, and/or service requirements of this specific user equipment and offered services in the area where said user equipment is located for the moment. From this information it is possible to predict the user channel and, thus, estimate the channel capacity for a given fixed transmission power with regard to various link adaptation and transmission schemes. Similarly, the system can predict a measure of the bit rate, e.g. as a maximum possible bit rate or a mean value thereof, that can be provided to the user equipment together with a measure of the time delay between the arrival of a data packet and the correct reception of said packet.

The estimated information, which is build on prediction values derived by the system according to the present invention can now be used as a possible contribution to a radio resource management strategy. The present invention allows the implementation of an intelligent scheduling mechanism: It uses predicted information about the movements of a user equipment and the radio conditions that are perceived by said user equipment. It applies said predicted information to schedule data of services with certain requirements on quality of service depending on the momentary and predicted channel capacity of said user equipment. One conceivable strategy can be to minimise the resource usage of each user equipment, e.g. the average transmission power, by help of the knowledge about the achievable channel capacity per user equipment and acceptable time delays for data packets in the system. According to another approach this knowledge could also be used to support a distribution of resources according to a certain scheme that is suggested by the radio resource management.

The following describes a further example of the usage of the status prediction database according to the present invention. The database content, in particular the prediction of movements of the user equipments, provides information for an improved prediction of channel and service requirements for each user equipment. This information is then used as a support for, e.g., admission and congestion control, scheduling, modulation, and link adaptation. This support is in particular beneficial for non-real time data.

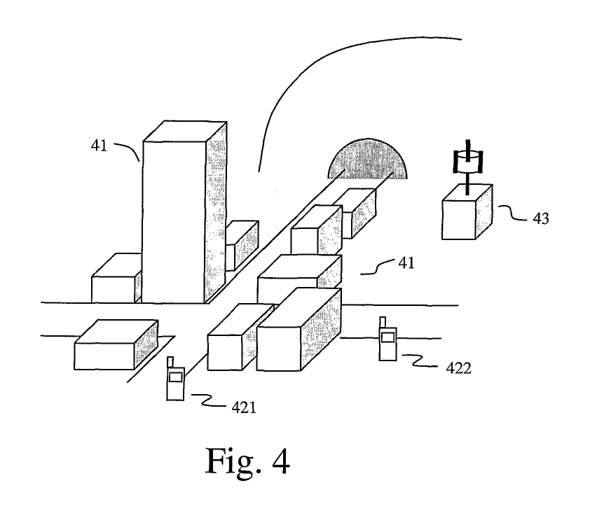

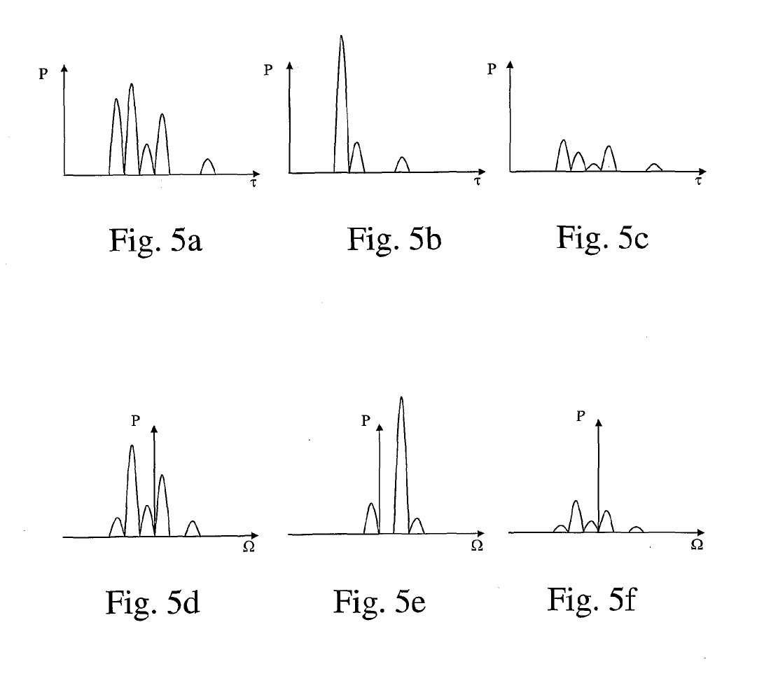

The present invention thus categorises cell profile information of a cell area in such a way that it can be used for radio resource and service predictions of user equipments moving around in such an area. For instance, the cell area, which is shown in FIG. 4, consists of various kinds of buildings 41 or other obstacles having certain influence on the propagation of radio waves to and from the radio base station 43 that serves said area. Depending on the position of a user equipment 421, 422 in relation to the radio base station 43 there is either a line-of-sight between user equipment 422 and said radio base station 43 or a user equipment 421 receives the transmitted signals from the radio base station 43 via a multipath propagation with various attenuations and time delays for the various propagation paths due to said buildings 41 or obstacles. These cell characteristics can be illustrated by a power delay profile or an angular profile as described above. FIGS. 5a-5f show some typical profile characteristics for certain propagation conditions. For a multipath scenario as shown in FIG. 5a the power is distributed on several paths, each of which having a certain time delay. The same applies for an angular multipath scenario as shown in FIG. 5d where each multipath is depicted by a certain angel. In case of a line-of-sight as shown in FIG. 5b and 5e there is one distinct power peek, which is characterised by a certain time delay or angel. Shadowing effects, which are shown in FIGS. 5c and 5f for a multipath scenario, will lead to a considerable attenuation of the power of the propagated signal depending on the kind of the shadowing obstacle. This suggests that it is possible to categorise the profile information of a cell area into clusters, each of which being specified by a representative geographical position, a route within said cell area, or a sub-area. Depending on available a-priori information of the cell area, e.g. roads, building types etc., it is possible to predict propagation conditions. In combination with further information about the user equipments this information can be further limited, and thus compressed, to those areas where most user equipments are located.

This is a part of the information, which is stored in the status prediction database and can be retrieved and applied for various purposes. FIG. 6 shows a Rake-receiver, which is improved by help of a status prediction database 61 according to the present invention. A Rake-receiver is commonly used in CDMA-systems and is constituted of four major functions, namely a path searcher 62, a channel estimator 63, a Rake combiner 64, and a decision element 65. The path searcher 62 finds the path positions, i.e. the delay times, in a radio link by investigating synchronisation signals. As depicted in FIG. 6, the path searcher 62 can be provided with the additional profile information from the status prediction database 61 in order to enhance the path searcher function. With this configuration, the path searcher can work more efficient with a-priori information so that it can track the correct paths even in the presence of a relatively large amount of interference and/or noise, or in the case where the channel type, e.g. multipath, line-of-sight, or shadowing, suddenly changes. In the latter case for instance the status prediction database 61 can anticipate the sudden change of the channel type so as to adapt the path search action to the expected status change that is going to occur. Then, the channel estimator 63 estimates the radio channel by examining the pilot signal providing the demodulation reference. The Rake combiner combines the dispersive paths coherently using said demodulation reference and achieves a high signal-to interference and noise ratio (SNIR) for demodulation. Finally, the decision element 65 recovers the modulated signal from the combined output that has been supplied by the Rake combiner.

In case of an angular profile application, the status prediction database 761, 762 can provide angular profile information to an adaptive array antenna, sometimes also referred to as “beam former”, which is introduced in cellular systems in order to increase the system capacity space-wise. FIG. 7a shows such an adaptive array antenna for a receiver and FIG. 7b shows the corresponding transmitter structure. For both receiver and transmitter the adaptive array antenna structure consists of an array controller 731, 732, array elements 711, 712, multiplies 721, 722 for weighting the array elements with weighting factors 791, 792 provided by the array controller. Furthermore, an array antenna for a receiver has an adder 74 to combine the signals from the array elements 711 and forward them to the receiver antenna output 77 while the array antenna for a transmitter has a divider 75 to split the transmitter antenna input 78 and deliver the signals to be transmitted to each of the array elements 712. By help of such a configuration, the adaptive array antenna can steer its beam to desired targets or nullify the radiation to and from undesired targets. The angular profile information from the status prediction database 761, 762 is provided to the array controller to enhance the array control function. The array controller can work more efficiently with this a-priori information so that it can track the correct angel of arrival (AOA) of desired targets or avoid the radiation to and from undesired targets even in the presence of relatively large amounts of interference and/or noise, or in cases where the channel type suddenly changes.

1. A system for providing radio resource management information within a certain geographic area in a communication network, comprising:
means for collecting input data relating to one of radio propagation conditions or service conditions at the location of user equipments;
means for retrieving estimates of the position and movement for one or several of said user equipments;
means for storing the achieved data with respect to at least either one of the parameters position, time, or user identity;
means for statistically processing said achieved data in order to determine an estimate of the channel capacity of said user equipments; and,
means for forwarding said data or estimates to one or more other network units.

2. The system according to claim 1, wherein said means for collecting and storing receive a location-dependent complex channel response information from various locations of said area.

3. The system according to claim 2, wherein said location-dependent radio propagation profile information is a power delay profile information that is provided by user equipments at said locations.

4. The system according to claim 2, wherein said location-dependent radio propagation profile information is a power angular profile information that is provided by the user equipments at said locations.

5. The system according to claim 1, wherein said means for collecting and storing receive path loss information.

6. The system according to claim 1, wherein said means for collecting and storing receive service requirement information.

7. The system according to claim 1, wherein the means for collecting include a pre-processing unit for sorting, filtering, and converting the received information.

8. The system according to claim 1, wherein said means for storing are equipped to store received data in a compressed or parameterised form.

9. The system according to claim 1, wherein the stored and refined power delay information is forwarded to a receiver.

10. The system according to claim 1, wherein the stored and refined power delay information is forwarded to the controller of an adaptive array antenna set.

11. A method in a communication network for providing radio resource management information within a certain geographic area, comprising the steps of:
collecting input data relating to one of radio propagation conditions or service conditions at the location of user equipments;
retrieving an estimate of the position and movement for one or several of said user equipments;
storing the achieved data with respect to at least either one of the parameters position, time, or user identity;
statistically processing said achieved data in order to determine an estimate of the channel capacity of said user equipments; and,
forwarding said data or estimates to one or more other network units.

12. The method according to claim 11, further comprising the step of performing link adaptation and scheduling to achieve a required quality of service for the estimated channel capacity.
